(19) United States
(12) Patent Application Publication
(10) Pub. No.: US 2014/0033248 A1
(43) Pub. Date: Jan. 30, 2014

(54) INCLUDING INSERTS IN MULTIMEDIA CONTENT

(71) Applicants: Andrew J. Aftelak, Palatine, IL (US); Young S. Lee, Palatine, IL (US); Venugopal Vasudevan, Palatine, IL (US); Jehan Wickramasuriya, St. Charles, IL (US)

(72) Inventors: Andrew J. Aftelak, Palatine, IL (US); Young S. Lee, Palatine, IL (US); Venugopal Vasudevan, Palatine, IL (US); Jehan Wickramasuriya, St. Charles, IL (US)

(73) Assignee: GENERAL INSTRUMENT CORPORATION, Horsham, PA (US)

(21) Appl. No.: 13/559,685

(22) Filed: Jul. 27, 2012

(51) Int. Cl. G06Q 30/02; H04N 21/80

(52) U.S. Cl. 725/32; 705/14.49; 705/14.1

(57) ABSTRACT

Disclosed are methods and apparatus for including an insert (e.g., an advertisement) in multimedia content. The method comprises receiving, by a receiving module, one or more indications, each indication being an indication that a consumer intends to consume, at some time in the future, the multimedia content. Using the indications, a value of a metric is then determined. The metric is dependent upon the number of received indications or one or more attributes of consumers whom the indications indicate intend to consume the multimedia content. An insert is then selected depending on the determined value for the metric. The selected insert is then included in the multimedia content.

### FIELD OF THE INVENTION

The present invention is related generally to making additions to multimedia content.

### BACKGROUND OF THE INVENTION

Typically, advertisers (e.g., advertisers who include their advertisements in or between television programs) want to maximize their return on investment by targeting their advertisements at people to whom their advertisements are relevant, e.g., to target their advertisements at a particular population demographic.

Also, advertisers typically want to be able to predict the number of people, or their demographics, that will be exposed to their advertisements. Accurate predictions of these parameters tend to facilitate advertisers in assessing the value of an advertising opportunity (e.g., an advertising slot in a television program) and in personalizing advertisements to groups or individuals.

In addition, advertisers typically want to be able to measure the success of advertisements.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing a television (TV) program;

FIG. 2 is a schematic illustration (not to scale) of an example scenario;

FIG. 3 is a schematic illustration (not to scale) of an advertising-services module; and

FIG. 4 is a process flow chart showing certain steps of an embodiment of a process of including advertisements in multimedia presentations.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Apparatus for implementing any of the below described arrangements, and for performing any of the below described method steps, may be provided by configuring or adapting any suitable apparatus, for example one or more computers or other processing apparatus or processors, or by providing additional modules. The apparatus may comprise a computer, a network of computers, or one or more processors for implementing instructions and using data, including instructions and data in the form of a computer program or plurality of computer programs stored in or on a machine-readable storage medium such as computer memory, a computer disk, ROM, PROM, etc., or any combination of these or other storage media.

It should be noted that certain of the process steps depicted in the below described process flowcharts may be omitted or such process steps may be performed in an order differing from that presented below and shown in those process flowcharts. Furthermore, although all the process steps have, for convenience and ease of understanding, been depicted as discrete temporally-sequential steps, nevertheless some of the process steps may in fact be performed simultaneously or at least overlapping to some extent temporally.

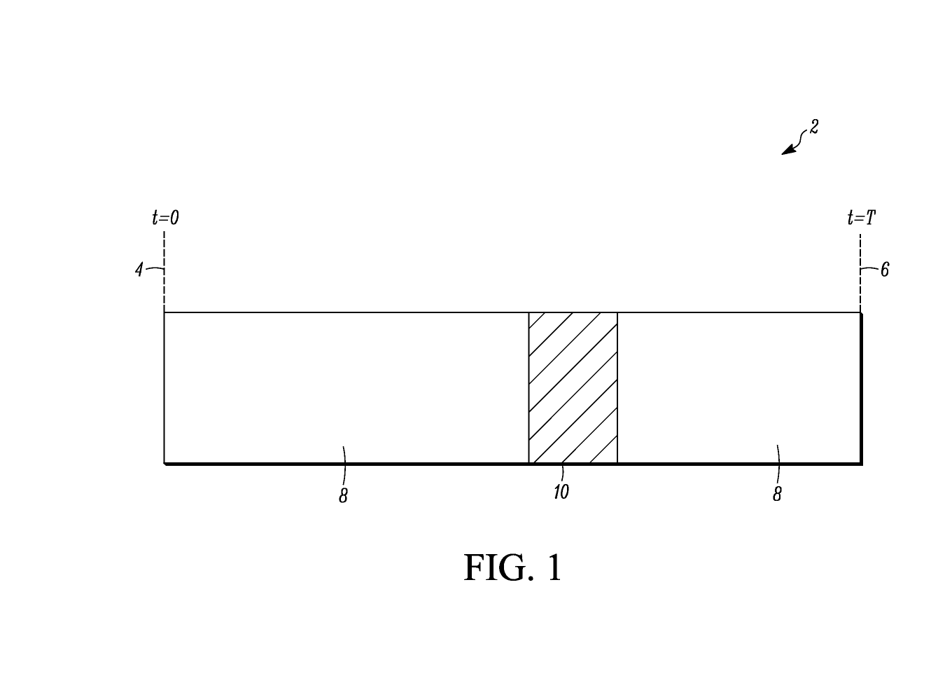

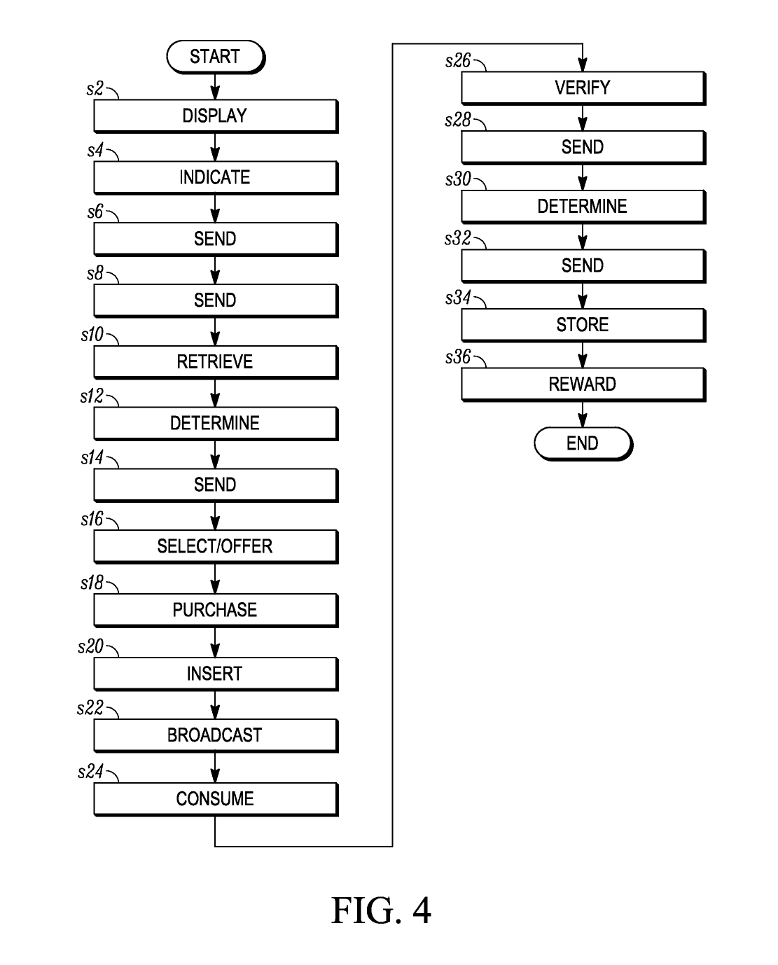

Referring now to the Figures, FIG. 1 is a schematic illustration (not to scale) showing an example of a TV program 2. The TV program 2 is used herein to illustrate embodiments of a process of including advertisements in multimedia presentations. In other embodiments, non-advertising content may be included in a multimedia presentation (e.g., a non-advertising multimedia insert). This process of including advertisements in multimedia presentations is described in more detail below with reference to FIG. 4. It will be appreciated that in other embodiments the process of including advertisements in multimedia presentations may be implemented with a different type of media presentation (e.g., a movie, an ebook, a radio broadcast, etc.).

The TV program 2 may be consumed by a consumer using any appropriate client device (e.g., a laptop computer, a tablet computer, a television). The TV program 2 runs from its start time 4 at time t=0 to its end time 6 at time t=T. In embodiments in which the media presentation is, e.g., an ebook, the media presentation may run from ‘page 1’ to ‘page N’ (where N is the number of pages in the ebook). Thus, as opposed to being time-based media, a media presentation may be non-time-based. The media presentation may also comprise a multi-device presentation, i.e., a multimedia presentation to be shown on more than one device. For example, the media presentation may comprise a slide presentation to be shown by one device and a video presentation to be shown by another device.

The TV program 2 comprises primary content 8 and an advertising opportunity 10. In other embodiments, the TV program 2 may comprise a plurality of advertising opportunities 10. Also, in other embodiments advertising opportunities 10 may be present before or after the primary content 8 instead of or in addition to during the primary content 8. The advertising opportunity 10 may be a “temporal advertising opportunity,” i.e., one that appears at some point in time in the TV program 2 and that separates portions of primary content 8. Alternatively, the advertising opportunity 10 may be a “spatial advertising opportunity,” i.e., one that appears in the primary content 8 and that occupies an amount of screen space, e.g., a product placement.

The primary content 8 may be any type of TV program content, for example, a documentary program, a film, a news broadcast, etc.

The advertising opportunity 10 is an opportunity, or slot, in the TV program 2 into which one or more advertisements (e.g., for products or services) may be inserted. The advertising opportunity 10 can exist outside the TV program 2 or may be embedded within it using known product-placement techniques. When the TV program 2 is consumed by a consumer (i.e., played back by a consumer), the consumer is exposed to the advertisements that have been inserted in the advertising opportunity 10 (e.g., the advertisements in the advertisement opportunities 10 are shown to the consumer). An advertisement may be any form of content that presents a brand, brand-related message, or brand-related purchase opportunity. This can include the following types of advertisement: (i) standard advertisements which may include rich media content, that may form part of an advertising campaign, and that may be supplementary to the primary content 8 (e.g., advertisements may be overlaid on the primary content 8, or may be in pre-roll, post-roll, or interim advertisement slots); (ii) product placements which may include rich media content that are seamlessly embedded or integrated into the primary content 8 (e.g., advertisements may be overlaid on to a billboard shown in a scene from the TV program 2); and (iii) product-purchase opportunities that can be associated with one of the preceding advertising types or can be presented in a stand-alone dialog (e.g., a companion application).

The advertisements may be included in the advertisement opportunity 10 as described in more detail below with reference to FIG. 4.

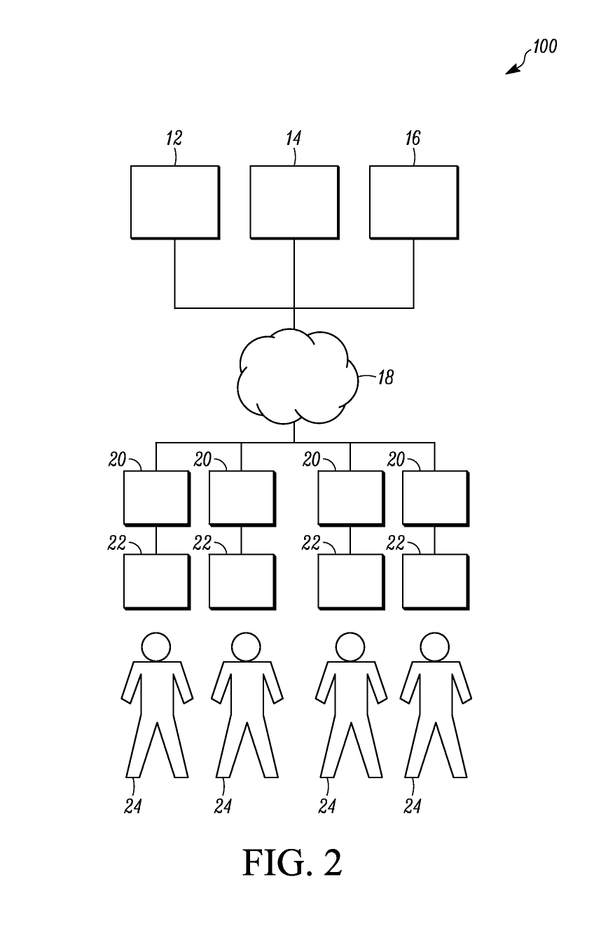

FIG. 2 is a schematic illustration (not to scale) of an example scenario 100. The entities of the scenario 100 are to perform the process of including advertisements in multimedia presentations.

The representative scenario 100 comprises a service provider 12, a set of advertisers 14, an advertising-services module 16, a network 18, a plurality of set-top boxes 20, a plurality of TVs 22, and a plurality of users 24.

The service provider 12 is a provider of the TV program 2, for example the service provider 12 may be a provider of cable-television or satellite-television services. The service provider 12 is connected (e.g., via a wireless link or over the Internet) to the advertisers 14 and to the advertising-services module 16. This connection is such that information may be sent among the service provider 12 and each of the advertisers 14 and the advertising-services module 16. Furthermore, the service provider 12 is connected to each of the set-top boxes 20 via the network 18. This connection is such that information (e.g., the TV program 2 with advertisements included in the advertising opportunity 10 of the TV program 2) may be sent from the service provider 12 to each of the set-top boxes 20.

Each of the advertisers 14 is a producer of advertisements for inclusion in the advertising opportunity 10 of the TV program 2. An advertiser 14 may include one or more of his advertisements in the advertising opportunity 10 of the TV program 2 as described in more detail below with reference to FIG. 4. In addition to being connected to the service provider 12, the advertisers 14 are connected to the advertising-services module 16 such that information may be passed among the advertisers 14 and the advertising-services module 16.

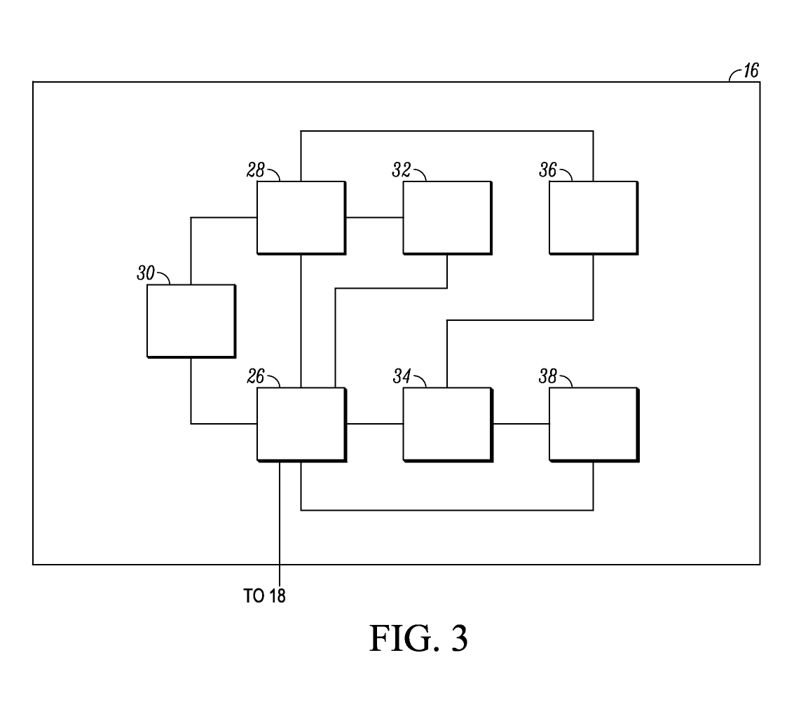

The advertising-services module 16 is described in more detail below with reference to FIG. 3. The functionality of the advertising-services module 16 is described in more detail below with reference to FIG. 4. In addition to being connected to the service provider 12 and to the advertisers 14, the advertising-services module 16 is connected to each of the set-top boxes 20 via the network 18. This connection is such that information may be sent from the advertising-services module 16 to each of the set-top boxes 20 as described in more detail below with reference to FIG. 4.

The network 18 may be any appropriate network, for example, a cable-television network, a satellite-television network, or the Internet.

Each of the set-top boxes 20 is connected to a respective TV 22 such that information received at the set-top box 20 via the network 18 (e.g., the TV program 2) may be displayed by that set-top box 20 on that respective TV 22 to a respective user 24. Furthermore, each of the set-top boxes 20 is such that information input into that set-top box 20 by the respective user 24 (e.g., either via the respective TV 22 or in response to information displayed to that user 24 on the respective TV 24) may be sent, via the network 18, to the advertising-services module 16, as described in more detail below with reference to FIG. 4.

The users 24 may be subscribers to the services provided by the advertising-services module 16.

In this embodiment, as described in more detail below with reference to FIG. 4, each user 24 may send information to the advertising-services module 16 using his TV 22 and set-top box 20. Also, the multimedia presentation (e.g., the TV program 2) may be displayed to a user 24 by his TV 22 and set-top box 20. However, in other embodiments each user 24 may send information to the advertising-services module 16 using a different device, for example, a different communications device, e.g., a computer such as a smartphone or a tablet computer. Also, in other embodiments the multimedia presentation may be displayed to a user 24 using a different device, for example, a different communications device, e.g., a computer such as a smartphone or a tablet computer.

FIG. 3 is a schematic illustration (not to scale) of the advertising-services module 16.

The advertising-services module 16 comprises a server 26, an analytics module 28, a database 30, a marketing module 32, a fulfillment module 34, a success-metrics module 36, and a reward-generation module 38.

The server 26 is a conventional server (e.g., a web-server). The server 26 is connected to the network 18 such that information may be sent among the server 26 and each of the set-top boxes 20, as described in more detail below with reference to FIG. 4. The server 26 is also connected to the analytics module 28, to the database 30, to the fulfillment module 34, and to the reward-generation module 38 such that information may be sent among the server 26 and each of the analytics module 28, the database 30, the fulfillment module 34, and the reward-generation module 38.

The analytics module 28 is configured to process information received at the analytics module 28 as described in more detail below with reference to FIG. 4. In addition to being connected to the server 26, the analytics module 28 is connected to each of the database 30, the marketing module 32, and the success-metrics module 36. These connections are such that information may be sent among the analytics module 28 and each of the database 30, the marketing module 32, and the success-metrics module 36.

The database 30 is configured to store information sent to it by the server 26. Also, the database 30 is configured to send information to the analytics module 28 (or allow information stored in the database 30 to be retrieved from the database 30 by the analytics module 28) for processing by the analytics module 28.

The marketing module 32 is connected, e.g., via the server 26, to the advertisers 14. This connection is such that, as described in more detail below with reference to FIG. 4, the marketing module 32 may, using information sent to it from the analytics module 28, market (i.e., offer for sale) some or all of the advertising opportunity 10 of the TV program 2 to the advertisers 14. In other embodiments, the marketing module 32 may be connected to the advertisers 14 in a different way (e.g., directly). An advertiser 14 who purchases a portion of the advertising opportunity 10 via the marketing module 32 may include his advertisements in the purchased portion of the advertising opportunity 10. In addition to being connected to the analytics module 28 and to the advertisers 14, the marketing module 32 is connected, via the server 26, to the service provider 12 such that information relating to the purchase of some or all of the advertising opportunity 10 may be sent from the marketing module 32 to the service provider 12. In other embodiments, the marketing module 32 may be connected to the service provider 12 in a different way (e.g., directly).

The functionality of the fulfillment module 34 is described in more detail below with reference to FIG. 4. The fulfillment module 34 is connected, e.g., via the server 26, to the set-top boxes 20 such that information may be sent from the set-top boxes 20, via the network 18 and the server 26, to the fulfillment module 34. In other embodiments, the fulfillment module 34 may be connected to the set-top boxes 20 in a different way (e.g., directly or via the network 18 only). The fulfillment module 34 is configured to process the received information. The fulfillment module 34 is further connected to the success-metrics module 36 and to the reward-generation module 38 such that an output of the information processing performed by the fulfillment module 34 may be sent to each of the success-metrics module 36 and the reward-generation module 38.

The functionality of the success-metrics module 36 is described in more detail below with reference to FIG. 4. The success-metrics module 36 is configured to process information received by it from the fulfillment module 34. The success-metrics module 36 is further connected to the analytics module 28 such that an output of the information processing performed by the success-metrics module 36 may be sent to the analytics module 28.

The functionality of the reward-generation module 38 is described in more detail below with reference to FIG. 4. The reward-generation module 38 is configured to process information received by it from the fulfillment module 34. The reward-generation module 38 is further connected, e.g., via the server 26 and the network 18, to the set-top boxes 20 such that an output of the information processing performed by the reward-generation module 38 may be sent to the set-top boxes 20. In other embodiments, the reward-generation module 38 may be connected to the set-top boxes 20 in a different way (e.g., directly or via the network 18 only).

FIG. 4 is a process flow chart showing certain steps of an embodiment of a process of including advertisements in multimedia presentations. The process of including advertisements in multimedia presentations is implemented by the entities described above with reference to FIGS. 2 and 3. However, in other embodiments, the process of including advertisements in multimedia presentations may be performed by different entities that may be arranged in a manner different from that described above with reference to FIGS. 2 and 3.

The TV program 2 is to be broadcast (i.e., provided for consumption) by the service provider 12 at some future point in time.

At step s2, an invitation inviting a user 24 to indicate his intention to watch (i.e., consume), at the future point in time, the TV program 2 may be displayed to each user 24 (e.g., on that user's TV 22). This may, for example, take the form of a message to a user 24 that is displayed on the user's TV 22 alongside a TV listing for the TV program 2. In other embodiments, the invitation may be displayed to a user 24 on a different user device, e.g., a smartphone, etc. In this embodiment, a user's intention to watch the TV program 2 is elicited directly from the user 24 (i.e., by providing the user 24 with an invitation inviting a user 24 to indicate his intention to watch). However, in other embodiments, a user's intention to consume multimedia content may be gleaned in a different way. Any appropriate way of determining whether a user 24 intends to consume certain multimedia content 2 or of determining what multimedia content 2 a user 24 intends to consume may be used. For example, a user's intentions may be elicited explicitly or implicitly from a program guide or from a list of events.

At step s4, one or more of the users 24 indicate that they intend to watch, at the future point in time (i.e., when the TV program 2 is broadcast by the service provider 12), the TV program 2. This may be performed in any appropriate way, for example, by a user 24 selecting an icon on his TV 22.

At step s6, the indications of the users' intentions with respect to watching, at the further point in time, the TV program 2 (which is hereinafter referred to as “indication data”) are sent from the TVs 22 and set-top boxes 20 of the users 24, via the network 18, to the server 26 of the advertising-services module 16. In other words, for each user 24 who indicates that he intends to watch, at the further time, the TV program 2, a signal indicating that user's intention to watch the TV program 2 is sent from that user's TV 22 and set-top box 20 (or other device) to the server 26. Thus, the server 26 may be considered to collect indications of what consumers 24 intend to consume. A consumer 24 may “sign-up” to view certain content 2 by providing the server 26 with an indication that he intends to view that content 2. The server 26 collects these “sign-up” indications.

Thus, at step s6, one or more users 24 register their intent to watch the future TV program 2 by sending a message to the server 26. A user 24 may register this intention in any appropriate way. For example, a user 24 may register his intention via an electronic program guide. Also for example, a user 24 may register his intention using a TV or a guide application on another device. Also for example, a user 24 may register his intention via a specific sign-up web site or a sign-up application on the TV 22 or on another device. Also for example, a user 24 may register his intention via an “events list” in which one of the events listed is the TV program 2. Also for example, a user 24 may register his intention in response to an advertisement for the TV program 2 on a mobile device or in an email message or in a text message.

At step s8, the indication data are sent from the server 26 to the analytics module 28.

At step s10, the analytics module 28 may retrieve data stored on the database 30. The data retrieved by the analytics module 28 may include, for example, data relating to the users 24 including, e.g., user profiles, user preferences, user behaviour, intentions of the users 24 with respect to watching previous TV programs, user age, user sex, user location, etc. Also, the data retrieved by the analytics module 28 may include, for example, data relating to the number of users 24 who indicated that they intend to watch a previous TV program and then actually watched that TV program. Also, the data retrieved by the analytics module 28 may include, for example, data relating to the advertising opportunities of previous TV programs including, e.g., the type of advertisements included in those advertising opportunities and the cost of including an advertisement in those advertising opportunities. Also, the data retrieved by the analytics module 28 may include, for example, data relating to the TV program 2 including, e.g., time of future broadcast, type of program, target demographic, etc. Also, the data retrieved by the analytics module 28 may include, for example, data relating to the audience including, e.g., previous audience figures, predictions of audience figures, audience demographics, etc.

At step s12, using the received indication data and the data retrieved from the database 30, the analytics module 28 determines a value for a metric. The value for this metric may be indicative of the worth (e.g., economic value) of the advertising opportunity 10 in the TV show 2. This metric value may depend on the number of users 24 who have indicated that they intend to watch, at the future time (i.e., when it is broadcast) the TV program 2. This metric value may also depend on any or all of the data retrieved by the analytics module 28 from the database 30. An example metric may be the number of users 24 who have indicated that they intend to watch the TV program 2. A further example metric may be the number of users 24 who have indicated that they intend to watch the TV program 2 multiplied by the proportion of users 24 who indicated that they intended to watch a previous TV program and actually did watch that previous TV program.

At step s14, the determined metric value is sent from the analytics module 28 to the marketing module 32.

At step s16, using the determined metric value, the marketing module 32 may select one or more advertisements (from one or more of the advertisers 14) for inclusion in some or all of the advertising opportunity 10. Instead of or in addition to selecting one or more advertisements, using the determined metric value, the marketing module 32 may offer for sale a portion of the advertising opportunity 10 such that an advertiser 14 may include one or more of his advertisements in the portion of the advertising opportunity 10 he purchases. The marketing module 32 may, for example, offer a portion of the advertising opportunity 10 for a fixed price (which may be dependent on the determined metric value). Alternatively, the marketing module 32 may, for example, auction a portion of the advertising opportunity 10 to the advertisers 14. (A starting price, or a reserve price, for the portion of the advertising opportunity 10 may be dependent on the determined metric value.)

At step s18, one or more of the advertisers 14 purchase some or all of the advertising opportunity 10 such that their advertisements may be included in that advertising opportunity 10 during broadcast of the TV program 2 to the users 24.

At step s20, for each advertiser 14 that purchased some or all of the advertising opportunity 10, advertisements from that advertiser 14 are included in the portion of the advertising opportunity 10 that was purchased by that advertiser 14. This inclusion of advertisements may be performed by the marketing module 32 or by a different module of the advertising-services module 16. Alternatively, this inclusion of advertisements may be performed by an entity other than the advertising-services module 16, e.g., the service provider 12.

At step s22, the TV program 2 (with the included advertisements) is broadcast by the service provider 12. The broadcast of the TV program 2 occurs at the future time. In other words, the service provider 12 delivers the TV program 2 (with the included advertisements) to the set-top boxes 20, via the network 18. The broadcast TV program 2 may be displayed to the users 24 on the TVs 22.

At step s24, one or more of the users 24 may watch the broadcast TV program 2 (with the advertisements included).

At step s26, a verification process is performed. The verification process may comprise, for each user 24 who indicated that he intended to watch the TV program 2 when the TV program 2 was broadcast, determining whether or not that user 24 actually watched the TV program 2. The verification process may be performed, at least in part, by the fulfillment module 34. In other words, the verification process is performed to verify whether or not a user 24 who indicated that he intended to watch the TV program 2 when it was broadcast (i.e., at the step s24) actually watched the TV program 2 when it was broadcast.

This verification process may be performed using any appropriate method. For example, the fulfillment module 34 may directly measures whether a user 24 watched the TV program 2. This may, for example, comprise a set-top box 20 informing the fulfillment module 34 that a user 24 watched the TV program 2, or the service provider 12 providing verification data to the fulfillment module 34. Also, TV check-in data, automatic content-recognition processes, etc., may be used instead of or in addition to verification data from the set-top boxes 20 or from the service provider 12. This verification process may comprise determining how much of the TV program 2 was watched by a user 24.

At step s28, for each user 24 who indicated that he intended to watch the TV program 2 when the TV program 2 was broadcast, the fulfillment module 34 sends data indicating whether or not that user 24 actually watched the TV program 2 to the success-metrics module 36 and to the reward-generation module 38.

At step s30, using the data received from the fulfillment module 34, the success-metrics module 36 determines a value of a metric that may measure the number or proportion of users 24 who actually watch a multimedia presentation after they have indicated that they intend to do so. This may be thought of as a “conversion value,” i.e., a value that is indicative of the number or proportion of successful conversions of a user's “intention to view” a multimedia presentation to a user's “actual viewing” of that multimedia presentation. The success-metrics module 36 may determine the average number (or proportion) of users who actually watch a multimedia presentation after they have indicated that they intend to do so. The success-metrics module 36 may determine historic conversion values (i.e., conversion values for previous different TV programs or previous showing of the same TV program). These historic conversion rates may be used to predict changes in conversion values or viewing numbers.

At step s32, the success-metrics module 36 sends the determined conversion values to the analytics module 28.

At step s34 the analytics module 28 may store, e.g., in the database 30, the determined conversion values. These conversion values may be used, e.g., by the analytics module 28 when determining metric values indicative of the worth (e.g., economic value) of other advertising opportunities, e.g., in other TV programs (e.g., future TV programs). In other words, the conversion values stored at step s34 may be used by the analytics module 28 at step s12 of future performances of the process of FIG. 4. In other words, at step s34, conversion values previously stored in the database 30 and used by the analytics module 28 at step s12 may be updated using the conversion values determined at step s30 and sent to the analytics module 28 at step s32. Also, the conversion values may be used, e.g., by the analytics module 28 or by the marketing module 32, to persuade advertisers 14 to purchase advertising opportunities.

At step s36, using the data received from the fulfillment module 34, the reward-generation module 38 may, for each user 24 who indicated his intention to watch the TV program 2 and actually did watch the TV program 2, generate a reward for that user 24. These rewards may be any form of reward. For example, a user 24 may be rewarded with “reward points” that may be credited to a user account, a voucher (e.g., a digital voucher or coupon for a product or service) may be generated for the user 24 and delivered (e.g., via the network 18) to that user 24. A reward for a user 24 may be proportional to the length of time for which that user 24 watched the TV program 2. This rewards mechanism advantageously tends to provide motivation for users 24 to both indicate their intentions to watch a multimedia presentation and then watch that multimedia presentation.

In other embodiments, a user 24 who indicates his intention to watch the TV program 2 and who then does not watch the TV program 2 may be penalized by the reward-generation module 38. For example, a user 24 who indicates that he intends to watch the TV program 2 and who then does not watch the TV program 2 when it is broadcast may be “fined” a number of reward points.

Thus, a process of including advertisements in multimedia presentations in provided.

An advantage provided by the above described methods and systems is that the advertisers tend to be provided with an indication of the likely viewing figures for a TV program. This may be determined from the number of users who indicate that they intend to watch a TV program. Also, advertisers tend to be provided with an indication of the likely population demographic of the viewers of a TV program. This tends to provide an indication to the advertisers of how valuable (to them) an advertising opportunity within that TV program is. An advertiser may use this information when deciding whether or not to pay to include an advertisement in a particular advertising opportunity.

Thus, advertisers tend to be facilitated in implementing cost-effective advertising campaigns. Also, advertisers tend to be facilitated in targeting advertisements at consumers to whom those advertisements are relevant. For example, advertisements may be selected for inclusion in an advertising opportunity based upon the user profiles of the users (or the demographic of users) who indicate that they intend to watch a TV program that includes that advertising opportunity.

Use of the user-provided information (i.e., information relating to which TV programs a user intends to watch) advantageously tends to increase the accuracy of a prediction of the number of viewers that will watch a future TV program. Also, predictions for viewer demographics tend to be more accurate. This tends to facilitate in the assessment (e.g., by the advertisers) of how valuable a particular advertising opportunity is. The users may be motivated to watch the TV programs that they indicate they intend to watch (i.e., the users may be motivated to supply accurate information for valuing an advertisement opportunity) using rewards or penalties.

Rewards may be received by consumers who indicate their future viewing intentions and then fulfill those intentions.

The above described methods and systems advantageously tend to provide a way of predicting, verifying, or gathering viewer demographics. The viewing of a TV program is also encouraged.

Furthermore, the above described methods and systems advantageously tend to provide a “success metric” (that may be indicative of the number or proportion of viewers who indicate that they intend to watch a TV program and then actually do). This may be used to assess the accuracy of predictions of the viewer number and demographics.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of including an insert in multimedia content, the method comprising:
receiving, by a receiving module, one or more indications, each indication being an indication that a consumer intends to consume, at some time in the future, the multimedia content;
using the indications, determining, by one or more processors operatively coupled to the receiving module, a value of a metric, the metric being dependent upon at least one parameter selected from the group consisting of: a number of received indications and an attribute of a consumer whom an indication indicates intends to consume the multimedia content;
selecting, by the one or more processors, depending on the determined value for the metric, an insert; and
including, by the one or more processors, the selected insert in the multimedia content.

2. A method according to claim 1 wherein the insert is an advertisement.

3. A method according to claim 1 further comprising:
providing for consumption by consumers whom the indications indicate intend to consume the multimedia content, by a providing module operatively coupled to the one or more processors, the multimedia content with the selected insert included therein; and
for each consumer whom the indications indicate intends to consume the multimedia content, determining, by the one or more processors, whether that consumer consumed at least some of the multimedia content with the selected insert included therein.

4. A method according to claim 3 further comprising determining, by the one or more processors, some function of a number of consumers whom the indications indicated intended to consume the multimedia content and who, at the future time, consumed at least some of the multimedia content.

5. A method according to claim 3:
wherein providing for consumption the multimedia content with the selected insert included therein is performed at the future time; and
wherein providing for consumption the multimedia content with the selected insert included therein comprises broadcasting the multimedia content with the selected insert included therein.

6. A method according to claim 3 further comprising:
for each consumer whom the indications indicated intended to consume the multimedia content and who, at the future time, consumed at least some of the multimedia content, generating a reward; and
providing, to each consumer for whom a reward has been generated, the reward generated for that consumer.

7. A method according to claim 1 wherein the metric is further dependent upon at least one parameter selected from the group consisting of:
a number of consumers who consumed, at a previous time, further multimedia content,
one or more attributes of consumers who consumed, at a previous time, further multimedia content,
a number of received further indications, each further indication being an indication that a consumer intended to consume, at a previous time, further multimedia content, and
one or more attributes of the multimedia content.

8. A method according to claim 1 wherein each of the received one or more indications is received from a consumer device, each of the received indications having been sent from a consumer device to the receiving module in response to a consumer performing an action using that consumer device, an action having been performed by a consumer to indicate that he intends to consume, at the future time, the multimedia content.

9. A method according to claim 1 wherein the multimedia content is a television program.

10. A method of including an advertisement in multimedia content, the method comprising:
receiving, by a receiving module, one or more indications, each indication being an indication that a consumer intends to consume, at some time in the future, the multimedia content;
using the indications, determining, by one or more processors operatively coupled to the receiving module, a value of a metric, the metric being dependent upon at least one parameter selected from the group consisting of: a number of received indications and an attribute of a consumer whom the indications indicate intends to consume the multimedia content;
offering, by the one or more processors to one or more advertisers, to include an advertisement in the multimedia content in exchange for payment, the level of payment being dependent on the determined value for the metric; and
in response to an advertiser accepting the offer to include an advertisement in the multimedia content in exchange for payment, including in the multimedia content, by the one or more processors, an advertisement specified by the advertiser that accepted the offer.

11. A method according to claim 10 further comprising:
providing for consumption by the consumers whom the indications indicate intend to consume the multimedia content, by a providing module operatively coupled to the one or more processors, the multimedia content with the specified advertisement included therein; and
for each consumer whom the indications indicate intends to consume the multimedia content, determining, by the one or more processors, whether that consumer consumed at least some of the multimedia content with the specified advertisement included therein.

12. A method according to claim 11 further comprising determining, by the one or more processors, some function of a number of consumers whom the indications indicated intended to consume the multimedia content and who, at the future time, consumed at least some of the multimedia content.

13. A method according to claim 11:
wherein providing for consumption the multimedia content with the specified advertisement included therein is performed at the future time; and
wherein providing for consumption the multimedia content with the selected advertisement included therein comprises broadcasting the multimedia content with the specified advertisement included therein.

14. A method according to claim 11 further comprising:
for each consumer whom the indications indicated intended to consume the multimedia content and who, at the future time, consumed at least some of the multimedia content, generating a reward; and
providing, to each consumer for whom a reward has been generated, the reward generated for that consumer.

15. A method according to claim 10 wherein the metric is further dependent upon at least one parameter selected from the group consisting of:
a number of consumers who consumed, at a previous time, further multimedia content,
one or more attributes of consumers who consumed, at a previous time, further multimedia content,
a number of received further indications, each further indication being an indication that a consumer intended to consume, at a previous time, further multimedia content, and
one or more attributes of the multimedia content.

16. A method according to claim 10 wherein each of the received one or more indications is received from a consumer device, each of the received indications having been sent from a consumer device to the receiving module in response to a consumer performing an action using that consumer device, an action having been performed by a consumer to indicate that he intends to consume, at the future time, the multimedia content.

17. A method of including an advertisement in multimedia content, the method comprising:
receiving, by a receiving module, one or more indications, each indication being an indication that a consumer intends to consume, at some time in the future, the multimedia content;
using the indications, determining, by one or more processors operatively coupled to the receiving module, a value of a metric, the metric being dependent upon at least one parameter selected from the group consisting of: a number of received indications and an attribute of a consumer whom the indications indicate intends to consume the multimedia content;
auctioning, by the one or more processors to one or more advertisers, to include an advertisement in the multimedia content; wherein either a starting price for the auction depends on the determined value for the metric or a reserve price for the auction depends on the determined value for the metric; and
thereafter, including in the multimedia content, by the one or more processors, an advertisement specified by the advertiser that is a highest bidder in the auction.

18. A method according to claim 17 further comprising:
providing for consumption by the consumers whom the indications indicate intend to consume the multimedia content, by a providing module operatively coupled to the one or more processors, the multimedia content with the specified advertisement included therein; and
for each consumer whom the indications indicate intends to consume the multimedia content, determining, by the one or more processors, whether that consumer consumed at least some of the multimedia content with the specified advertisement included therein.

19. A method according to claim 17 wherein the metric is further dependent upon at least one parameter selected from the group consisting of:
a number of consumers who consumed, at a previous time, further multimedia content,
one or more attributes of consumers who consumed, at a previous time, further multimedia content,
a number of received further indications, each further indication being an indication that a consumer intended to consume, at a previous time, further multimedia content; and
one or more attributes of the multimedia content.

20. Apparatus for including an advertisement in multimedia content, the apparatus comprising:
a receiving module configured to receive one or more indications, each indication being an indication that a consumer intends to consume, at some time in the future, the multimedia content; and
one or more processors operatively coupled to the receiving module and configured to:
using the indications, determine a value of a metric, the metric being dependent upon at least one parameter selected from the group consisting of: a number of received indications and an attribute of a consumer whom the indications indicate intends to consume the multimedia content;
select, depending on the determined value for the metric, an advertisement; and
include, in the multimedia content, the selected advertisement.

21. Apparatus for including an advertisement in multimedia content, the apparatus comprising:
a receiving module configured to receive one or more indications, each indication being an indication that a consumer intends to consume, at some time in the future, the multimedia content; and
one or more processors operatively coupled to the receiving module and configured to:
using the indications, determine a value of a metric, the metric being dependent upon at least one parameter selected from the group consisting of: a number of received indications and an attribute of a consumer whom the indications indicate intends to consume the multimedia content;
offer, to one or more advertisers, to include an advertisement in the multimedia content in exchange for payment, the level of payment being dependent on the determined value for the metric; and
in response to an advertiser accepting the offer to include an advertisement in the multimedia content in exchange for payment, include in the multimedia content an advertisement specified by the advertiser that accepted the offer.

22. Apparatus for including an advertisement in multimedia content, the apparatus comprising:
a receiving module configured to receive one or more indications, each indication being an indication that a consumer intends to consume, at some time in the future, the multimedia content; and
one or more processors operatively coupled to the receiving module and configured to:
using the indications, determine a value of a metric, the metric being dependent upon at least one parameter selected from the group consisting of: a number of received indications and an attribute of a consumer whom the indications indicate intends to consume the multimedia content;
auction, to one or more advertisers, to include an advertisement in the multimedia content, wherein either a starting price for the auction depends on the determined value for the metric, or a reserve price for the auction depends on the determined value for the metric; and
thereafter, include, in the multimedia content, an advertisement specified by an advertiser that is a highest bidder in the auction.
